(19) United States
(12) Patent Application Publication
(10) Pub. No.: US 2026/0147360 A1
(43) Pub. Date: May 28, 2026

(54) SURVEYING A GEOGRAPHICAL AREA USING A PLURALITY OF AUTONOMOUS ROBOTS

(71) Applicant: GM Global Technology Operations LLC, Detroit, MI (US)

(72) Inventors: Md Mhafuzul Islam, West Bloomfield, MI (US); Arun Adiththan, Sterling Heights, MI (US); Jacob Alan Bond, Rochester Hills, MI (US); Azeem Sarwar, Rochester Hills, MI (US); Maureen Elizabeth August, Gross Pointe Woods, MI (US); Michael Zerr, Royal Oak, MI (US)

(73) Assignee: GM Global Technology Operations LLC, Detroit, MI (US)

(21) Appl. No.: 18/962,704

(22) Filed: Nov. 27, 2024

(51) Int. Cl. G05D 1/648; G05D 1/644; G05D 1/689; G05D 105/80

(52) U.S. Cl. CPC G05D 1/6482; G05D 1/644; G05D 1/689; G05D 2105/87

(57) ABSTRACT

A method includes receiving a request to create a map of a geographical area, obtaining geographical-area parameters representing characteristics of the area, subdividing, based on the geographical-area parameters, the area into a plurality of sub-regions, and obtaining, for each of a plurality of robots, corresponding robot parameters representing characteristics of the robot. For each particular sub-region, the method also includes determining, based on the geographical-area parameters, corresponding sub-region parameters representing characteristics of the particular sub-region, assigning, based on the sub-region parameters and the robot parameters, a particular robot to survey the particular sub-region, and obtaining corresponding survey data captured by the particular robot, the survey data representing a survey of the particular sub-region by the particular robot. The method also includes combining the corresponding survey data captured by the assigned robots to generate the high-fidelity map of the geographical area.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

A map of a geographical area may be generated by surveying the geographical area. In some examples, equipment such as a camera is used to survey the geographical area. In other examples, a human manually surveys the geographical area.

The present disclosure relates generally to surveying a geographical area using a plurality of autonomous robots.

### SUMMARY

One aspect of the disclosure provides a system including a plurality of robots configured to survey assigned sub-regions of a geographical area, a server in communication with the plurality of robots. The system is configured to perform operations including receiving a request to create a high-fidelity map of the geographical area, obtaining a plurality of geographical-area parameters representing characteristics of the geographical area, subdividing, based on the plurality of geographical-area parameters, the geographical area into a plurality of sub-regions, and obtaining, for each particular robot of the plurality of robots, a corresponding plurality of robot parameters representing characteristics of the particular robot. The operations include, for each particular sub-region of the plurality of sub-regions determining, based on the plurality of geographical-area parameters, a corresponding plurality of sub-region parameters representing characteristics of the particular sub-region, assigning, based on the corresponding plurality of sub-region parameters and the corresponding pluralities of robot parameters, a particular robot of the plurality of robots to survey the particular sub-region, and obtaining corresponding survey data captured by the particular robot, the corresponding survey data representing a survey of the particular sub-region by the assigned particular robot. The operations also include combining the corresponding survey data captured by the assigned robots to generate the high-fidelity map of the geographical area.

Implementations of the disclosure may include one or more of the following optional features. In some implementations, each assigned robot is configured to perform operations including determining, based on the corresponding plurality of sub-region parameters for an assigned sub-region and the corresponding pluralities of robot parameters, at least one of a route or a method for surveying the assigned sub-region, navigating to the assigned sub-region, capturing, based on the at least one of the route or the method, the corresponding survey data representing a survey of the particular sub-region, and providing the corresponding survey data to the server.

In some examples, assigning, based on the corresponding plurality of sub-region parameters and the corresponding pluralities of robot parameters, a particular robot of the plurality of robots to survey the particular sub-region includes reducing an amount of energy expended by the assigned robots. Additionally, or alternatively, assigning, based on the corresponding plurality of sub-region parameters and the corresponding pluralities of robot parameters, a particular robot of the plurality of robots to survey the particular sub-region includes maximizing a coverage of the geographical area. Additionally, or alternatively, assigning, based on the corresponding plurality of sub-region parameters and the corresponding pluralities of robot parameters, a particular robot of the plurality of robots to survey the particular sub-region includes reducing a survey time.

In some implementations, the corresponding plurality of robot parameters representing characteristics of a particular robot include at least one of an ability to navigate on ground, an ability to navigate on water, an ability to navigate in water, an ability to navigate aerially, a battery status, a charging time, a robot type, a robot location, a coverage area, a cost to travel a unit of distance, a shape, one or more sensor types, or one or more communication interfaces. In some examples, the corresponding plurality of sub-region parameters representing characteristics of a particular sub-region includes at least one of a presence of shadow, a presence of sunshine, a topology, a presence of water, an altitude, one or more geographical hazards, a traversable surface, or a surface type.

In some examples, combining the corresponding survey data captured by the assigned robot to generate the high-fidelity map of the geographical area includes, for each particular sub-region of the plurality of sub-regions, extracting from the corresponding survey data one or more features and one or more locations corresponding to the one or more features, determining, based the one or more features and the one or more locations, an alignment of the corresponding survey data with the corresponding survey data captured by a different robot, and combining, using the alignment, the corresponding survey data and the corresponding survey data captured by the different robot. Combining, using the alignment, the corresponding survey data and the corresponding survey data captured by the different robot may include using a weighted feature score. The one or more features may be weighted using a first fidelity score assigned to the corresponding survey data and a second fidelity score assigned to the corresponding survey data captured by the different robot.

Another aspect of the disclosure provides a computer-implemented method executed by data processing hardware that causes the data processing hardware to perform operations. The operations including receiving a request to create a high-fidelity map of the geographical area, obtaining a plurality of geographical-area parameters representing characteristics of the geographical area, subdividing, based on the plurality of geographical-area parameters, the geographical area into a plurality of sub-regions, and obtaining, for each particular robot of the plurality of robots, a corresponding plurality of robot parameters representing characteristics of the particular robot. The operations include, for each particular sub-region of the plurality of sub-regions, determining, based on the plurality of geographical-area parameters, a corresponding plurality of sub-region parameters representing characteristics of the particular sub-region, assigning, based on the corresponding plurality of sub-region parameters and the corresponding pluralities of robot parameters, a particular robot of the plurality of robots to survey the particular sub-region, and obtaining corresponding survey data captured by the particular robot, the corresponding survey data representing a survey of the particular sub-region by the assigned particular robot. The operations also include combining the corresponding survey data captured by the assigned robots to generate the high-fidelity map of the geographical area.

Implementations of the disclosure may include one or more of the following optional features. In some implementations, combining the corresponding survey data captured by the assigned robot to generate the high-fidelity map of the geographical area includes, for each particular sub-region of the plurality of sub-regions, extracting from the corresponding survey data one or more features and one or more locations corresponding to the one or more features, determining, based the one or more features and the one or more locations, an alignment of the corresponding survey data with the corresponding survey data captured by a different robot, and combining, using the alignment, the corresponding survey data and the corresponding survey data captured by the different robot.

In some examples, combining, using the alignment, the corresponding survey data and the corresponding survey data captured by the different robot includes using a weighted feature score. The one or more features may be weighted using a first fidelity score assigned to the corresponding survey data and a second fidelity score assigned to the corresponding survey data captured by the different robot. In some implementations, assigning, based on the corresponding plurality of sub-region parameters and the corresponding pluralities of robot parameters, a particular robot of the plurality of robots to survey the particular sub-region includes at least one of reducing an amount of energy expended by the assigned robots, maximizing a coverage of the geographical area, or reducing a survey time.

Yet another aspect of the disclosure provides a system including data processing hardware and memory hardware in communication with the data processing hardware. The memory hardware stores instructions that, when executed on the data processing hardware, cause the date processing hardware to perform operations. The operations including receiving a request to create a high-fidelity map of the geographical area, obtaining a plurality of geographical-area parameters representing characteristics of the geographical area, subdividing, based on the plurality of geographical-area parameters, the geographical area into a plurality of sub-regions, and obtaining, for each particular robot of the plurality of robots, a corresponding plurality of robot parameters representing characteristics of the particular robot. The operations include, for each particular sub-region of the plurality of sub-regions, determining, based on the plurality of geographical-area parameters, a corresponding plurality of sub-region parameters representing characteristics of the particular sub-region, assigning, based on the corresponding plurality of sub-region parameters and the corresponding pluralities of robot parameters, a particular robot of the plurality of robots to survey the particular sub-region, and obtaining corresponding survey data captured by the particular robot, the corresponding survey data representing a survey of the particular sub-region by the assigned particular robot. The operations also include combining the corresponding survey data captured by the assigned robots to generate the high-fidelity map of the geographical area.

Implementations of the disclosure may include one or more of the following optional features. In some implementations, combining the corresponding survey data captured by the assigned robot to generate the high-fidelity map of the geographical area includes, for each particular sub-region of the plurality of sub-regions, extracting from the corresponding survey data one or more features and one or more locations corresponding to the one or more features, determining, based the one or more features and the one or more locations, an alignment of the corresponding survey data with the corresponding survey data captured by a different robot, and combining, using the alignment, the corresponding survey data and the corresponding survey data captured by the different robot.

In some examples, combining, using the alignment, the corresponding survey data and the corresponding survey data captured by the different robot includes using a weighted feature score. The one or more features may be weighted using a first fidelity score assigned to the corresponding survey data and a second fidelity score assigned to the corresponding survey data captured by the different robot. In some implementations, assigning, based on the corresponding plurality of sub-region parameters and the corresponding pluralities of robot parameters, a particular robot of the plurality of robots to survey the particular sub-region includes at least one of reducing an amount of energy expended by the assigned robots, maximizing a coverage of the geographical area, or reducing a survey time.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example surveying system incorporating a plurality of autonomous robots in accordance with the principles of the present disclosure.

FIG. 2 is a flowchart of an example arrangement of operations for a method of using a plurality of autonomous robots for surveying a geographical area.

FIG. 3 is a flowchart of an example arrangement of operations for a method of subdividing a geographical area into sub-regions and assigning autonomous robots to the sub-regions.

FIG. 4 is a flowchart of an example arrangement of operations for a method of combining survey data captured by a plurality of autonomous robots.

FIG. 5 is a flowchart of another example arrangement of operations for a method of combining survey data captured by a plurality of autonomous robots.

FIG. 6 is a flowchart of another example arrangement of operations for a method of using a plurality of autonomous robots for surveying a geographical area.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

A map of a geographical area may be generated by surveying the geographical area. In some examples, equipment such as a camera, a light detection and ranging (LiDAR) system, a depth camera, etc. is used to survey the geographical area. In other examples, a human manually surveys the geographical area. However, especially for geographical areas that are difficult to survey, conventional survey techniques may not be able to adequately survey such difficult-to-survey geographical areas. Example difficult-to-survey geographical areas include, but are not limited to, a military installation or site; an off-road area; a jungle area; a desert area; a farmland area; an area after a natural disaster (e.g., an earthquake or a hurricane) changed roads, traffic patterns, topology, etc.; an area after a man-made disaster (e.g., an explosion, a spill, a military operation, etc.); an area potentially unsafe for humans or animals; etc. It is beneficial to survey such difficult areas to help speed up the delivery of help or supplies; to reduce traffic congestion; save lives by assessing how help may be provided; speed up recovery efforts; prioritize the clearing of roads; determining routes for traversing a geographical area; etc. Therefore, there is a need for improved methods and systems for surveying geographical areas, especially geographical areas difficult, unsafe, or impractical to survey using conventional techniques. In disclosed examples, robots of a plurality of autonomous robots are optimally assigned to particular sub-regions of a geographical area and then autonomously survey their assigned sub-region(s). Survey data collected by the autonomous robots are then optimally combined to create a high-fidelity map of the geographical area. Here, the autonomous robots can survey the sub-regions prior to it being safe for humans to enter. In some examples, autonomous robots survey a geographical area in real time to facilitate real time decision-making regarding the geographical area.

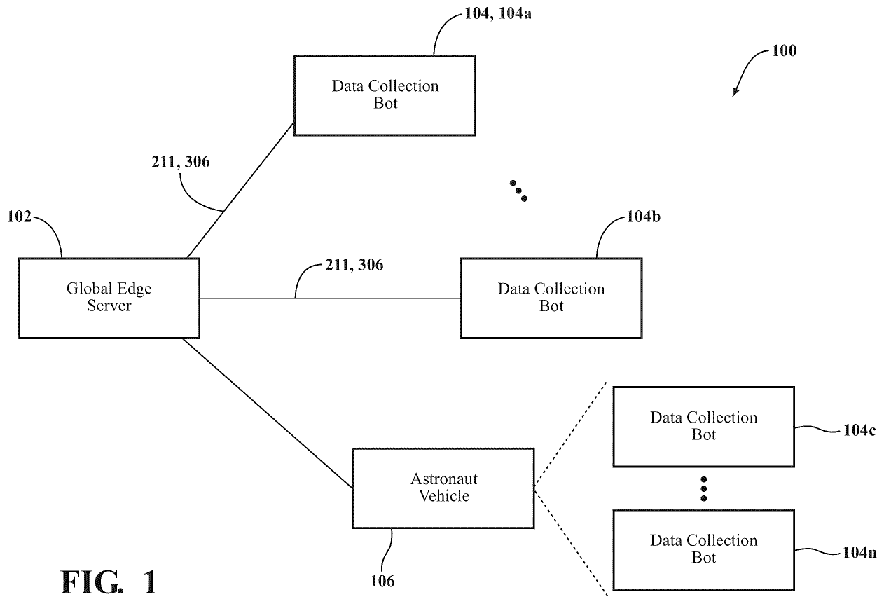

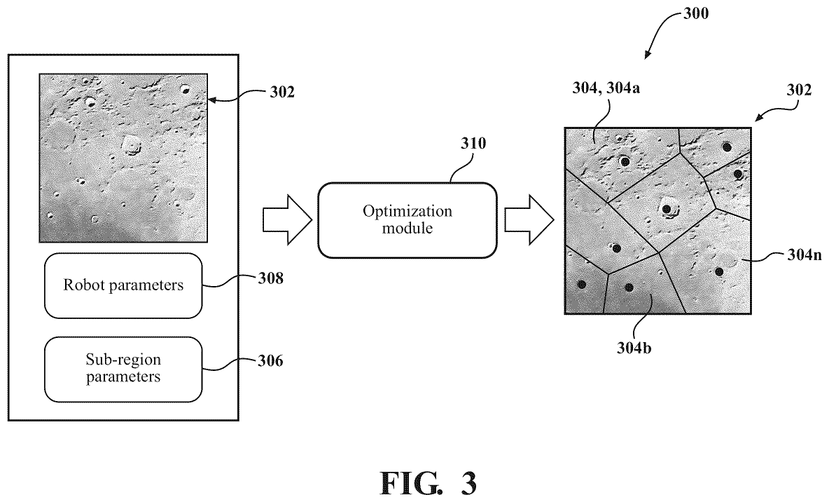

FIG. 1 is a schematic view of an example surveying system 100 incorporating a server 102 and a plurality of autonomous robots 104, 104a-n (also referred to as robots 104) configured to autonomously survey assigned sub-regions 304, 304a-n of a geographical area 302 (see FIG. 3). As shown, a carrier or astronaut vehicle 106 may be used to transport one or more of the robots 104 closer to the geographical area 302 or assigned sub-regions 304. An autonomous robot 104 may be any type of vehicle (e.g., car or truck), robot, drone, component, etc. capable of autonomous movement, action, or data capture. Here, the robots 104 may include different types of robots, such that different types of robots may be used to survey different types of areas.

The server 102 sub-divides a geographical area 302 to be surveyed into sub-regions 304, assigns one or more of the robots 104 to survey each sub-region 304, obtains survey data 211 from the assigned robots 104, and combines the survey data 211 to generate a high-fidelity map of the geographical area 302. Here, the server 102 sub-divides the geographical area 302 based on geographical-area parameters representing characteristics of the geographical area such that each sub-region 304 can be surveyed by a particular type of robot 104. For example, sub-regions 304 may correspond to areas of water, areas of dry land, areas of wet land, mountainous or hilly areas, jungle areas, shaded areas, sunny areas, etc. Each sub-region 304 has corresponding sub-region parameters 306 representing characteristics of the sub-region 304. In some examples, the sub-region parameters 306 are taken from, or derived from, the geographical-area parameters. The server 102 assigns one or more robots 104 to each sub-region 304 based on sub-region parameters 306 representing characteristics of the sub-region 304 and robot parameters 308 (see FIG. 3) representing characteristics of each robot 104. In some examples, the server 102 assigns robots 104 to sub-regions 304 to, for example, reduce or minimize an amount of energy expended by the assigned robots 104, to increase or maximize a coverage of the geographical area 302, or to reduce or minimize a survey time.

Example geographical-area parameters and sub-region parameters 306 include, but are not limited to, a presence of shadow, a presence of sunshine, a topology, a presence of water, an altitude, one or more geographical hazards, a traversable surface (e.g., a drivable surface), or a surface type (e.g., vegetation, off-road, gravel road, etc.).

Example robot parameters 308 include, but are not limited to, an ability to navigate on the ground, an ability to navigate on water, an ability to navigate in water, an ability to navigate aerially, a battery status, a charging time, a robot type, a robot location, a coverage area, a cost to travel a unit of distance, a shape, one or more sensor types, or one or more communication interfaces.

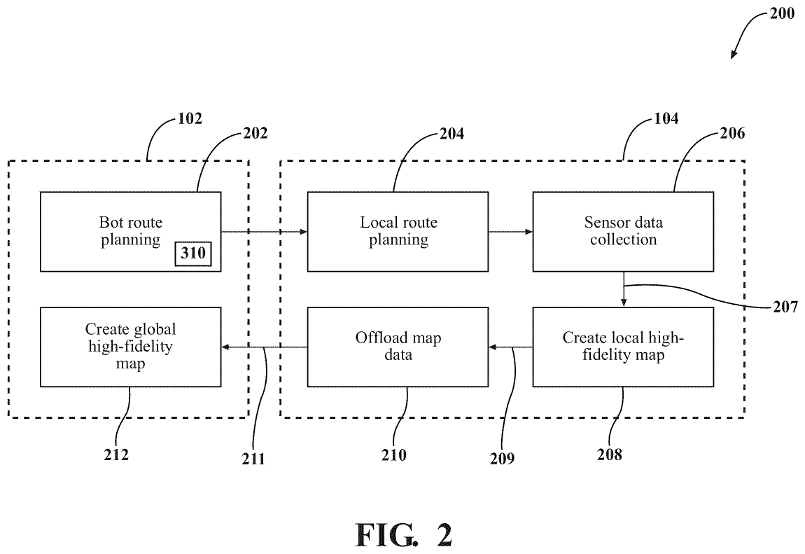

The robot(s) 104 assigned to survey a particular sub-region 304 are configured to autonomously determine, based on the sub-region parameters 306 for the sub-region 304 and their robot parameters 308, a route and/or a method for surveying the assigned sub-region 304. The robot(s) 104 then navigate to the assigned sub-region 304, and capture, based on the route and/or the method, survey data 211 (see FIG. 2) representing a survey of the sub-region 304. In some examples, the robots 104 autonomously navigate and survey their assigned sub-regions 304. Alternatively, one or more robots 104 may be remotely operated by the server 102 and/or a person. In some implementations, a robot 104 may also survey the route the robot 104 takes to an assigned sub-region 304.

Thereafter, the robot(s) 104 provide the survey data 211 to the server 102, and the server 102 combines the survey data 211 to generate a high-fidelity map of the geographical area 302.

In some implementations, the server 102 sub-divides the geographical area 302 based on an initial or low-fidelity map of the geographical area 302. Moreover, in some examples, the process of generating the high-fidelity map is repeated. For example, the high-fidelity map may be fed back into the system 100 to generate better sub-regions 304 and/or to make a better deployment strategy of robots 104 to the sub-regions 304. For instance, a non-traversable area may be discovered in a particular sub-region 304, which requires a robot 104 with different capabilities to be re-deployed to the same sub-region 304. Thus, by repeating the process, the fidelity of the generated map may increase over time with each deployment.

FIG. 2 is a flowchart of an exemplary arrangement of operations for a computer-implemented method 200 of using a plurality of autonomous robots 104 for surveying a geographical area 302. The operations may be performed by data processing hardware of the server 102 or robots 104 based on executing instructions stored on memory hardware of the server 102 or robots 104. Many other ways of implementing the method 200 may be employed. For example, the order of execution of the operations may be changed, and/or one or more of the operations and/or interactions may be changed, eliminated, sub-divided, or combined. Additionally, the operations of FIG. 2 may be carried out sequentially and/or in parallel by, for example, separate processing threads, processors, devices, discrete logic, circuits, etc.

At operation 202, the method 200 includes the server 102 performing robot route planning. In some examples, performing robot route planning includes sub-dividing, e.g., based on a high-level or low-resolution map, the geographical area 302 to be surveyed into sub-regions 304, assigning one or more of the robots 104 to survey each sub-region 304, and determining a route for each robot 104 to take to its assigned sub-region(s) 304. As shown in FIG. 3, assigning one or more robots 104 to survey each sub-region 304 is based on sub-region parameters 306 representing characteristics of the sub-region 304 and robot parameters 308 representing characteristics of each robot 104. As shown in the example method 300 of FIG. 3, an optimization module 310 may optimize the assignment of robots 104 to sub-regions 304 to, for example, reduce or minimize an amount of energy expended by the assigned robots 104, to increase or maximize a coverage of the geographical area 302, or to reduce or minimize a survey time. More than one robot 104 may be assigned to survey a sub-region 304, a particular robot 104 may be assigned to survey multiple sub-regions 304, and a particular robot 104 may not be assigned to survey any sub-region 304 of the geographical area 302.

At operation 204, the method 200 includes each assigned robot 104 determining, based on the corresponding plurality of sub-region parameters 306 for an assigned sub-region 304 and its robot parameters 308, a route and/or a method for surveying the assigned sub-region 304. In some implementations, each robot 104 autonomously determines its route and/or method for surveying their assigned sub-region(s) 304.

At operation 206, the method 200 includes each assigned robot 104 capturing, based on the route and/or the method, data 207 representing a survey of the assigned sub-region 304. At operation 208, the method 200 includes each assigned robot 104 creating a local high-fidelity map 209 of an assigned sub-region 304 based on the captured data 207. Thereafter, at operation 210, the method 200 includes each assigned robot 104 providing, transmitting or otherwise offloading survey data 211 representing the data 207 and/or the local high-fidelity map 209 of the assigned sub-region 304.

At operation 212, the method 200 includes the server 102 combining the survey data 211 from the assigned robot(s) 104 to generate a high-fidelity map of the geographical area 302.

Any method may be used for combining survey data 211, 211a-n captured by a plurality of autonomous robots 104 to generate a high-fidelity map of a geographical area 302. An example method is described in “Highly Efficient Image Stitching Based on Energy Map,” by Tang et al, which was published in 2009 2nd International Congress on Image and Signal Processing, IEEE, 2009, which is available at https://ieeexplore.ieee.org/abstract/document/5304214, and which is incorporated herein in its entirety. Another example method is described in “Automatic Panoramic Image Stitching using Invariant Features,” which was published in International Journal of Computer Vision 74 (2007): 59-73, which is available at https://link.springer.com/article/10.1007/s11263-006-0002-3, and which is incorporated herein in its entirety. Yet another example method is described in “Adaptive As-Natural-As-Possible Image Stitching,” by Chung-Ching et al., which was published in Proceedings of the IEEE Conference on Computer Vision and Pattern Recognition, 2015, which is available at https://www.cv-foundation.org/openaccess/content_cvpr_2015/html/Lin_Adaptive_As-Natural-As-Possible_Image_2015_CVPR_paper.html, and which is incorporated herein in its entirety. A still further method is described in “Color Image Fidelity Metrics Evaluated Using Image Distortion Maps,” by Zhang et al, which was published in Signal Processing 70.3 (1998): which 201-214, is available at https://www.sciencedirect.com/science/article/abs/pii/S016516849800125X, and which is incorporated herein in its entirety.

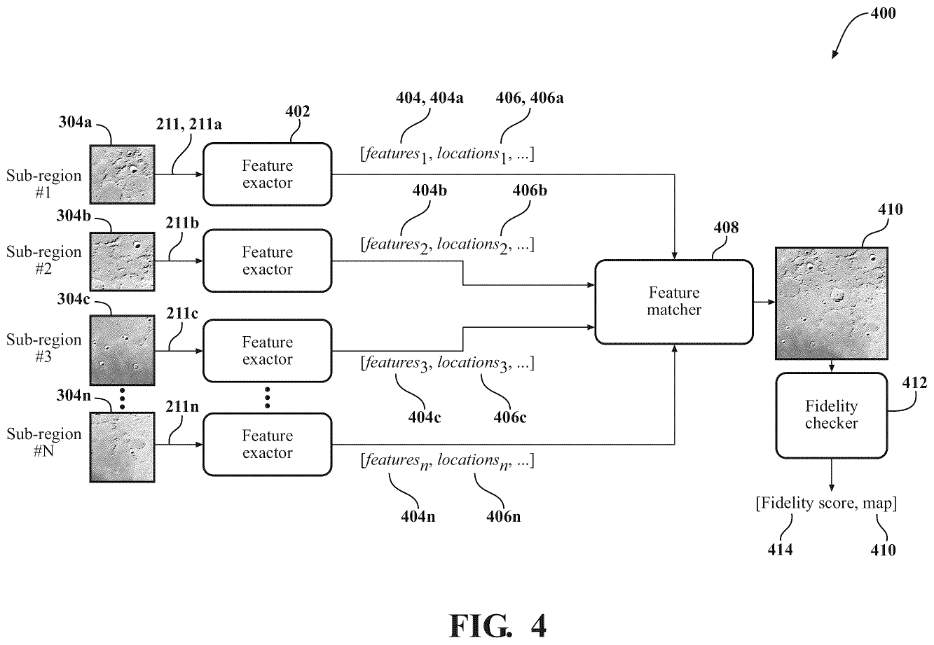

FIG. 4 is a flowchart of another example arrangement of operations for a method of combining survey data 211, 211a-n captured by a plurality of autonomous robots 104. The operations may be performed by data processing hardware of the server 102 or robots 104 based on executing instructions stored on memory hardware of the server 102 or robots 104. Many other ways of implementing the method 400 may be employed. For example, the order of execution of the operations may be changed, and/or one or more of the operations and/or interactions may be changed, eliminated, sub-divided, or combined. Additionally, the operations of FIG. 4 may be carried out sequentially and/or in parallel by, for example, separate processing threads, processors, devices, discrete logic, circuits, etc.

At operation 402, the method 400 includes processing, using a feature extractor, the survey data 211, 211a-n captured for a particular sub-region 304, to generate, identify, or extract a plurality of features 404, 404a-n and a corresponding plurality of locations 406, 406a-n of the features 404. In some examples, the feature extractor includes one or more machine learning (ML) models trained to generate, identify, or extract features in image data. In other examples, the feature extractor uses a scale invariant feature transformation to extract the features in image data.

At operation 408, the method 400 includes processing, using a feature matcher, the features 404 and the locations 406, to match features between different sets of survey data 211 and, based on the matched features stich together the survey data 211 into a high-quality map 410 of the geographic area 302. In some examples, the feature matcher matches features 404 using as-projective-as-possible image stitching, shape-preserving half-projective image stitching, or some combination thereof.

At operation 412, the method 400 includes processing, using a fidelity checker, the high-quality map 410 and the survey data 211, to generate one or more fidelity scores 414. Example fidelity scores 414 include, but are not limited to, an average Euclidian distance between matched features and a spatial information index. In some examples, includes one or more machine learning (ML) models trained to generate a fidelity score for a stitched together image.

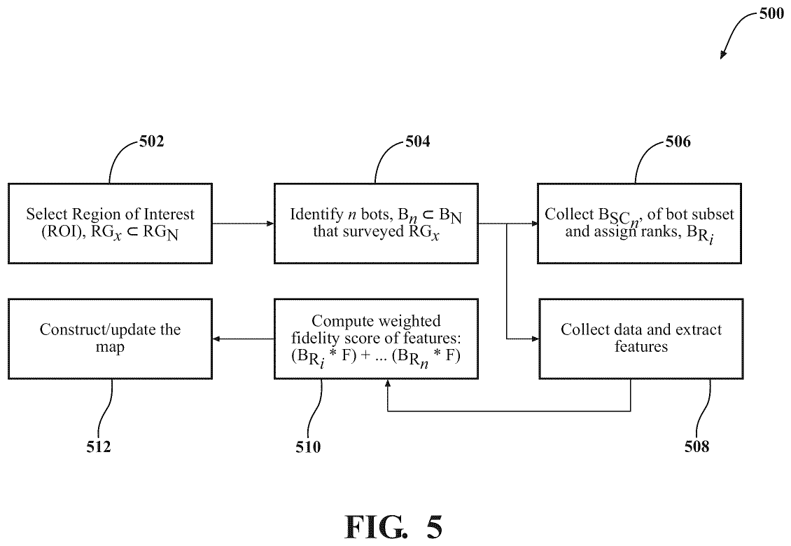

FIG. 5 is a flowchart of another example arrangement of operations for a method of combining survey data 211, 211a-n captured by a plurality of autonomous robots 104. The operations may be performed by data processing hardware of the server 102 or robots 104 based on executing instructions stored on memory hardware of the server 102 or robots 104. Many other ways of implementing the method 500 may be employed. For example, the order of execution of the operations may be changed, and/or one or more of the operations and/or interactions may be changed, eliminated, sub-divided, or combined. Additionally, the operations of FIG. 5 may be carried out sequentially and/or in parallel by, for example, separate processing threads, processors, devices, discrete logic, circuits, etc.

When a particular sub-region 304 is surveyed by multiple robots 104, the method 500 ensures that the survey data 211 collected by the robots 104 are verified for consistency and aggregated appropriately.

In the illustrated example of FIG. 5, RGₓ refers to the x^{th} sub-region 304, Bₙ refers to the n^{th} robot 104, and B_{sc}_{ₙ} refers to the robot parameters 308 of the n^{th} robot 104. At operation 502, the method 500 includes selecting a region of interest (ROI) RGₓ 304 of a geographical area 302 being surveyed. At operation 504, the method 500 includes identifying the robots Bₙ 104 that surveyed the selected ROI RGₓ 304.

At operation 506, the method includes obtaining the robot parameters B_{sc}_{ₙ} 308 for each of the robots Bₙ 104 identified at operation 504, and assigning ranks BR; to the sensors of each robot Bₙ 104. In particular, the robots Bₙ 104 identified at operation 504 may have varied sets of capabilities. For instance, the robots Bₙ 104 may differ in terms of type(s) and/or number of sensors (e.g., robot A may have a high-precision camera and LiDAR, while robot B only has a high-precision camera). Accordingly, the information collected by the robots 104 will be weighted based on their sensor suites, by assigning higher rank BR, and fidelity score to the survey data 211 collected by robots 104 having more sophisticated sensor suites.

At operation 508, the method 500 includes obtaining survey data 211 from each of the robots Bₙ 104 identified at operation 504, and processing the survey data 211 to generate, identify, or extract a plurality of features and a corresponding plurality of locations. In some examples, the features are extracted using one or more machine learning (ML) models trained to generate, identify, or extract features in image data. Alternatively, features may be extracted using a scale invariant feature transformation to extract the features in image data.

At operation 510, the method 500 includes computing a weighted fidelity score S of feature ranks. In some examples, the weighted fidelity score maybe computed as:

$$S = ( {B}_{{R}_{i}} * F ) + ⋯ + ( {B}_{{R}_{n}} * F ) \qquad EQN ( 1 )$$

where F is a matrix of weights reflecting the fidelity of different types of sensors. Here, the weighted fidelity score S arbitrates disagreements about a specific sub-region's features 404 between the robots 104 that surveyed a sub-region 304. This arbitration logic resolves disagreements on the extracted features 404 of a sub-region 304 based on corresponding the robot fidelity scores S. Once the features or characteristics of a sub-region 304 are resolved, the survey data 211 will be used to update the local map 410 for the corresponding sub-region 304.

At operation 512, the method 500 includes combining the survey data 211 from the assigned robot(s) 104 to generate a high-fidelity map of the geographical area 302.

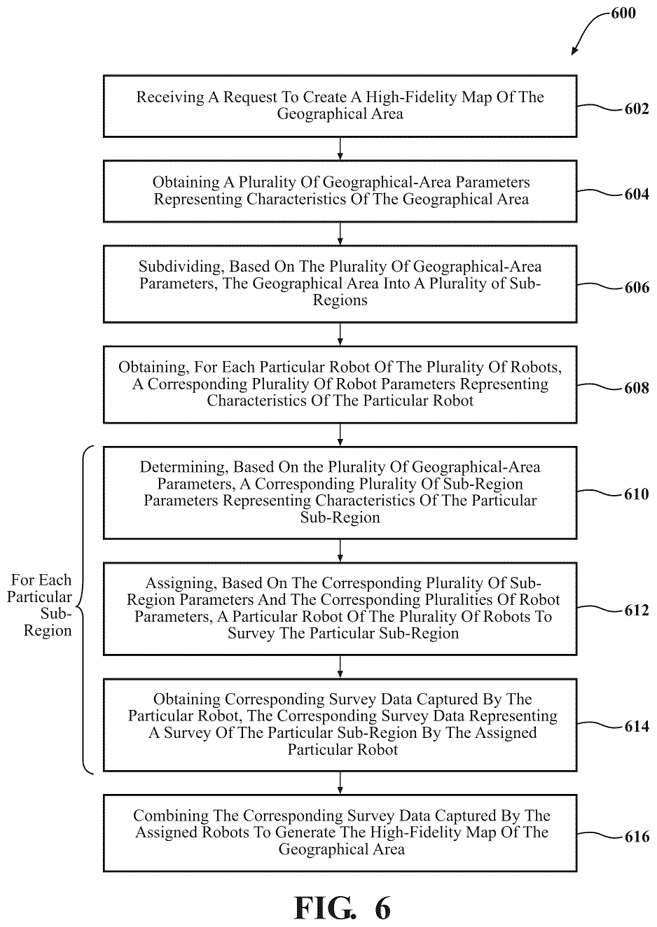

FIG. 6 is a flowchart of an exemplary arrangement of operations for a computer-implemented method 600 of using a plurality of autonomous robots 104 for surveying a geographical area 302. The operations may be performed by data processing hardware of the server 102 or robots 104 based on executing instructions stored on memory hardware of the server 102 or robots 104. Many other ways of implementing the method 600 may be employed. For example, the order of execution of the operations may be changed, and/or one or more of the operations and/or interactions may be changed, eliminated, sub-divided, or combined. Additionally, the operations of FIG. 6 may be carried out sequentially and/or in parallel by, for example, separate processing threads, processors, devices, discrete logic, circuits, etc.

At operation 602, the method 600 includes receiving a request to create a high-fidelity map of a geographical area 302. At operation 602, the method 600 includes obtaining a plurality of geographical-area parameters representing characteristics of the geographical area 302. At operation 604, the method 600 includes subdividing, based on the plurality of geographical-area parameters, the geographical area 302 into a plurality of sub-regions 304. At operation 606, the method 600 includes obtaining, for each particular robot 104 of a plurality of robots 104, a corresponding plurality of robot parameters 308 representing characteristics of the particular robot 104.

For each particular sub-region 304 of the plurality of sub-regions 304, at operation 610, the method 600 includes determining, based on the plurality of geographical-area parameters, a corresponding plurality of sub-region parameters 306 representing characteristics of the particular sub-region 304. For each particular sub-region 304 of the plurality of sub-regions 304, at operation 612, the method 600 includes assigning, based on the corresponding plurality of sub-region parameters 306 and the corresponding pluralities of robot parameters 308, a particular robot 104 of the plurality of robots 104 to survey the particular sub-region 304. For each particular sub-region 304 of the plurality of sub-regions 304, at operation 614, the method 600 includes obtaining corresponding survey data 211 captured by the particular robot 104, the corresponding survey data 211 representing a survey of the particular sub-region 304 by the assigned particular robot 104.

At operation 616, the method 600 includes combining the corresponding survey data 211 captured by the assigned robots 104 to generate the high-fidelity map 410 of the geographical area 302. In some examples, combining the corresponding survey data 211 captured by the assigned robot 104 to generate the high-fidelity map 410 of the geographical area 302 includes, for each particular sub-region 304 of the plurality of sub-regions 304, extracting from the corresponding survey data 211 one or more features 404 and one or more locations 406 corresponding to the one or more features 404; determining, based the one or more features 404 and the one or more locations 406, an alignment of the corresponding survey data 211 with the corresponding survey data 211 captured by a different robot 104; and combining, using the alignment, the corresponding survey data 211 and the corresponding survey data 211 captured by the different robot 104. In some implementations, combining, using the alignment, the corresponding survey data 211 and the corresponding survey data 211 captured by the different robot 104 includes using a weighted feature score. Here, one or more features are weighted using a first fidelity score assigned to the corresponding survey data 211 and a second fidelity score assigned to the corresponding survey data 211 captured by the different robot 104.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A system comprising:
a plurality of robots configured to survey assigned sub-regions of a geographical area; and
a server in communication with the plurality of robots and configured to perform operations comprising:
receiving a request to create a high-fidelity map of the geographical area;
obtaining a plurality of geographical-area parameters representing characteristics of the geographical area;
subdividing, based on the plurality of geographical-area parameters, the geographical area into a plurality of sub-regions;
obtaining, for each particular robot of the plurality of robots, a corresponding plurality of robot parameters representing characteristics of the particular robot;
for each particular sub-region of the plurality of sub-regions:
determining, based on the plurality of geographical-area parameters, a corresponding plurality of sub-region parameters representing characteristics of the particular sub-region;
assigning, based on the corresponding plurality of sub-region parameters and the corresponding pluralities of robot parameters, a particular robot of the plurality of robots to survey the particular sub-region; and
obtaining corresponding survey data captured by the particular robot, the corresponding survey data representing a survey of the particular sub-region by the assigned particular robot; and
combining the corresponding survey data captured by the assigned robots to generate the high-fidelity map of the geographical area.

2. The system of claim 1, wherein each assigned robot is configured to perform operations comprising:
determining, based on the corresponding plurality of sub-region parameters for an assigned sub-region and the corresponding pluralities of robot parameters, at least one of a route or a method for surveying the assigned sub-region;
navigating to the assigned sub-region;
capturing, based on the at least one of the route or the method, the corresponding survey data representing a survey of the particular sub-region; and
providing the corresponding survey data to the server.

3. The system of claim 1, wherein assigning, based on the corresponding plurality of sub-region parameters and the corresponding pluralities of robot parameters, a particular robot of the plurality of robots to survey the particular sub-region comprises reducing an amount of energy expended by the assigned robots.

4. The system of claim 1, wherein assigning, based on the corresponding plurality of sub-region parameters and the corresponding pluralities of robot parameters, a particular robot of the plurality of robots to survey the particular sub-region comprises maximizing a coverage of the geographical area.

5. The system of claim 1, wherein assigning, based on the corresponding plurality of sub-region parameters and the corresponding pluralities of robot parameters, a particular robot of the plurality of robots to survey the particular sub-region comprises reducing a survey time.

6. The system of claim 1, wherein the corresponding plurality of robot parameters representing characteristics of a particular robot comprises at least one of:
an ability to navigate on ground;
an ability to navigate on water;
an ability to navigate in water;
an ability to navigate aerially;
a battery status;
a charging time;
a robot type;
a robot location;
a coverage area;
a cost to travel a unit of distance;
a shape;
one or more sensor types; or
one or more communication interfaces.

7. The system of claim 1, wherein the corresponding plurality of sub-region parameters representing characteristics of a particular sub-region comprises at least one of:
a presence of shadow;
a presence of sunshine;
a topology;
a presence of water;
an altitude;
one or more geographical hazards;
a traversable surface; or
a surface type.

8. The system of claim 1, wherein combining the corresponding survey data captured by the assigned robot to generate the high-fidelity map of the geographical area comprises:
for each particular sub-region of the plurality of sub-regions, extracting from the corresponding survey data one or more features and one or more locations corresponding to the one or more features;
determining, based the one or more features and the one or more locations, an alignment of the corresponding survey data with the corresponding survey data captured by a different robot; and
combining, using the alignment, the corresponding survey data and the corresponding survey data captured by the different robot.

9. The system of claim 8, wherein combining, using the alignment, the corresponding survey data and the corresponding survey data captured by the different robot comprises using a weighted feature score.

10. The system of claim 9, wherein the one or more features are weighted using a first fidelity score assigned to the corresponding survey data and a second fidelity score assigned to the corresponding survey data captured by the different robot.

11. A computer-implemented method executed by data processing hardware that causes the data processing hardware to perform operations comprising:
receiving a request to create a high-fidelity map of a geographical area;
obtaining a plurality of geographical-area parameters representing characteristics of the geographical area;
subdividing, based on the plurality of geographical-area parameters, the geographical area into a plurality of sub-regions;
obtaining, for each particular robot of the plurality of robots, a corresponding plurality of robot parameters representing characteristics of the particular robot;
for each particular sub-region of the plurality of sub-regions:
determining, based on the plurality of geographical-area parameters, a corresponding plurality of sub-region parameters representing characteristics of the particular sub-region;
assigning, based on the corresponding plurality of sub-region parameters and the corresponding pluralities of robot parameters, a particular robot of the plurality of robots to survey the particular sub-region; and
obtaining corresponding survey data captured by the particular robot, the corresponding survey data representing a survey of the particular sub-region by the assigned particular robot; and
combining the corresponding survey data captured by the assigned robots to generate the high-fidelity map of the geographical area.

12. The computer-implemented method of claim 11, wherein combining the corresponding survey data captured by the assigned robot to generate the high-fidelity map of the geographical area comprises:
for each particular sub-region of the plurality of sub-regions, extracting from the corresponding survey data one or more features and one or more locations corresponding to the one or more features;
determining, based the one or more features and the one or more locations, an alignment of the corresponding survey data with the corresponding survey data captured by a different robot; and
combining, using the alignment, the corresponding survey data and the corresponding survey data captured by the different robot.

13. The computer-implemented method of claim 12, wherein combining, using the alignment, the corresponding survey data and the corresponding survey data captured by the different robot comprises using a weighted feature score.

14. The computer-implemented method of claim 13, wherein the one or more features are weighted using a first fidelity score assigned to the corresponding survey data and a second fidelity score assigned to the corresponding survey data captured by the different robot.

15. The computer-implemented method of claim 11, wherein assigning, based on the corresponding plurality of sub-region parameters and the corresponding pluralities of robot parameters, a particular robot of the plurality of robots to survey the particular sub-region comprises at least one of:
reducing an amount of energy expended by the assigned robots;
maximizing a coverage of the geographical area; or
reducing a survey time.

16. A system comprising:
data processing hardware; and
memory hardware in communication with the data processing hardware and storing instructions that, when executed by the data processing hardware, cause the data processing hardware to perform operations comprising:
receiving a request to create a high-fidelity map of a geographical area;
obtaining a plurality of geographical-area parameters representing characteristics of the geographical area;
subdividing, based on the plurality of geographical-area parameters, the geographical area into a plurality of sub-regions;
obtaining, for each particular robot of the plurality of robots, a corresponding plurality of robot parameters representing characteristics of the particular robot;
for each particular sub-region of the plurality of sub-regions:
determining, based on the plurality of geographical-area parameters, a corresponding plurality of sub-region parameters representing characteristics of the particular sub-region;
assigning, based on the corresponding plurality of sub-region parameters and the corresponding pluralities of robot parameters, a particular robot of the plurality of robots to survey the particular sub-region; and
obtaining corresponding survey data captured by the particular robot, the corresponding survey data representing a survey of the particular sub-region by the assigned particular robot; and
combining the corresponding survey data captured by the assigned robots to generate the high-fidelity map of the geographical area.

17. The system of claim 16, wherein combining the corresponding survey data captured by the assigned robot to generate the high-fidelity map of the geographical area comprises:
for each particular sub-region of the plurality of sub-regions, extracting from the corresponding survey data one or more features and one or more locations corresponding to the one or more features;
determining, based the one or more features and the one or more locations, an alignment of the corresponding survey data with the corresponding survey data captured by a different robot; and
combining, using the alignment, the corresponding survey data and the corresponding survey data captured by the different robot.

18. The system of claim 17, wherein combining, using the alignment, the corresponding survey data and the corresponding survey data captured by the different robot comprises using a weighted feature score.

19. The system of claim 18, wherein the one or more features are weighted using a first fidelity score assigned to the corresponding survey data and a second fidelity score assigned to the corresponding survey data captured by the different robot.

20. The system of claim 16, wherein assigning, based on the corresponding plurality of sub-region parameters and the corresponding pluralities of robot parameters, a particular robot of the plurality of robots to survey the particular sub-region comprises at least one of:
reducing an amount of energy expended by the assigned robots;
maximizing a coverage of the geographical area; or
reducing a survey time.
